(19) United States
(12) Patent Application Publication
(10) Pub. No.: US 2003/0026519 A1
(43) Pub. Date: Feb. 6, 2003

(54) Integrated optic device

(75) Inventor: Stephen William Roberts, Winchester (GB)

Correspondence Address: SUGHRUE MION, PLLC, 2100 PENNSYLVANIA AVENUE, N.W., WASHINGTON, DC, 20037, US

(73) Assignee: BOOKHAM TECHNOLOGY, PLC.

(21) Appl. No.: 10/206,671

(22) Filed: Jul. 29, 2002

(30) Foreign Application Priority Data
Jul. 31, 2001 (GB) 0118637.8

(51) Int. Cl. G02B 6/12; G02B 6/34

(52) U.S. Cl. 385/14; 385/37

(57) ABSTRACT

A wavelength-dispersive device for processing a multi-channel optic signal, the device including an optic chip defining first and second diffraction gratings coupled via a first free propagation region, the second diffraction grating coupled at its output end to an array of light-receiving elements via a second free propagation region, each light-receiving element positioned to selectively receive a respective channel of the multi-channel signal, and wherein the first free propagation region includes a spatial filter defined by selective doping of the optic chip so as to preferentially transmit a selected portion of the output from the first diffraction grating to the second diffraction grating and thereby reduce cross-talk at the array of light-receiving elements.

### FIELD OF THE INVENTION

The present invention relates to an integrated optic device, particularly to an integrated optic device including a spatial filter.

### BACKGROUND OF THE INVENTION

Spatial filters are used in a range of optical devices such as, for example, demultiplexers comprising two concatenated array waveguide gratings, which are connected in series via a shared free propagation region. Such a device is described in U.S. Pat. No. 5,926,587, whose entire content is incorporated herein by reference. The spatial filter is used to avoid high levels of crosstalk. In the devices described in U.S. Pat. No. 5,926,587, the spatial filter is located within the shared free propagation region and is created either by a pinhole or slit in an otherwise opaque barrier, by a reflector that collects and focuses only the desired light from one router to the other, by a set of waveguides spread over a finite range or by a multi-mode interferometer (MMI) waveguide.

### SUMMARY OF THE INVENTION

According to the present invention, there is provided an integrated optic device including first and second optic components defined in an optical chip and in optical communication via a spatial filter, wherein the spatial filter is defined by selective doping of the optical chip.

According to another aspect of the present invention, there is provided a wavelength-dispersive device for processing a multi-channel optic signal, the device including an optic chip defining first and second diffraction gratings coupled via a first free propagation region, the second diffraction grating coupled at its output end to an array of light-receiving elements via a second free propagation region, each light-receiving element positioned to selectively receive a respective channel of the multi-channel signal, and wherein the first free propagation region includes a spatial filter defined by selective doping of the optic chip so as to preferentially transmit a selected portion of the output from the first diffraction grating to the second diffraction grating and thereby reduce cross-talk at the array of light-receiving elements.

### BRIEF DESCRIPTION OF THE DRAWINGS

An embodiment of the present invention is described hereunder, by way of example only, with reference to the accompanying drawings, in which:

FIG. 1 is a view of an integrated optic device according to a first embodiment of the present invention;

FIG. 2 is a cross-sectional view of the optical chip of the device shown in FIG. 1 in the region of the spatial alter; and

FIGS. 3 and 4 are graphs showing examples of opacity profiles for the spatial filter.

### DESCRIPTION OF A PREFERRED EMBODIMENT

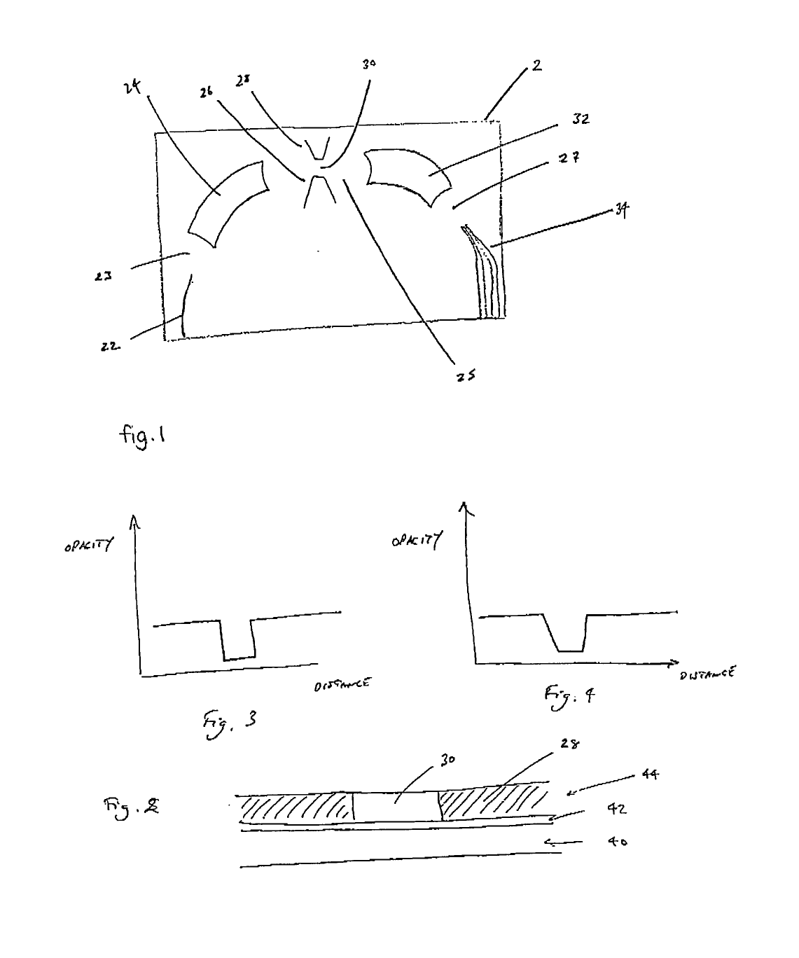

With reference to FIG. 1, a demultiplexer according to an embodiment of the present invention comprises a silicon-on-insulator chip (SOI) 2 having a number of elements defined in the chip 2. A first input waveguide 24 is separated from a first array waveguide grating 26 by a first free propagation region 23. A second array waveguide grating 32 shares a second free propagation region 25 with the first array waveguide grating 24 and is separated from an array of output waveguides 34 by a third free propagation region 27. The input waveguide 22, output waveguides 34 and the waveguides that constitute the array waveguide gratings 24,32 are rib waveguides defined by etching the silicon layer of the SOI chip 2. The free propagation regions are unetched slab regions. A spatial filter 26 is defined in the second free propagation region 26 by doping selected portions 28 of the free propagation region with a material that increases the optical absorptivity and hence the opacity of the silicon. Between the high opacity doped regions 28 is an undoped portion 30, which constitutes an “aperture” of low opacity compared to the doped regions 28.

A cross-section of the SOI chip in the region of the spatial filter is shown in FIG. 2, the SOI chip comprising the epitaxial silicon layer 44 formed on a silicon substrate 40 via a layer of silicon dioxide 42.

Doping techniques of the kind used in the electronics industry for other purposes may be used. For example, electronic doping of the silicon layer may be carried out by ion implantation of either phosphorous, boron or arsenic (or any other dopant which modifies the optical absorptivity of silicon) and subsequent thermal activation.

The dopant concentration within each doped region may be controlled to be uniform to provide a spatial filter having an on/off opacity profile of the kind shown in FIG. 3, or the dopant concentration can be controlled to increase with increasing distance away from the undoped region 30 to provide a spatial filter having a graded opacity profile of the kind shown in FIG. 4.

In use, a wavelength multiplexed signal comprising a plurality of component channels is introduced into the input waveguide 22, and each of the component channels is collected via a respective output waveguide 34. Unwanted light output from the first array waveguide grating 24 into the second free propagation region 25 is largely absorbed by the doped regions thereby reducing the amount of unwanted light that is input into the second array waveguide grating 32. Undesirable scattering of light from the walls of the “aperture” should be greatly reduced because of the absorbing nature of the doped regions, which define the walls of the “aperture”.

The first and second array waveguide gratings are designed and configured relative to each other so as to provide a demultiplexer having a relatively broad and flat filter pass-bands. The inclusion of a spatial filter in the free propagation region between the two AWGs allows tailoring of the resultant overall filter transmission spectrum by engineering the spatial profile of the absorption within the shared free propagation region. In a preferred embodiment, the first AWG has a free spectral range that equals the frequency spacing between adjacent output waveguides 34 at the output end of the second AWG, which corresponds to the channel spacing of the multiplexed signal to be processed; this arrangement allows broad and flat filter pass-bands with relatively low loss. In this preferred embodiment, the spatial filter serves to achieve a steeply sloping filter cut-off and thus reduce cross-talk between channels at the output of the demultiplexer.

A number of modifications may be made to the demultiplexer described above. For example, other diffraction gratings such as reflective-type gratings of the kind described in EP0365125 may be used in place of the array waveguide gratings employed in the embodiments described above.

The applicant draws attention to the fact that the present invention may include any feature or combination of features disclosed herein either implicitly or explicitly or any generalisation thereof without limitation to the scope of any definitions set out above. In view of the foregoing description it will be evident to a person skilled in the art that various modifications may be made within the scope of the invention. For example, the present invention is not limited to application in silicon chips; it also has application in chips made of other materials whose optical absorption can be varied by doping.

What is claimed is:

1. An integrated optic device including first and second optic components defined in an optic chip and in optical communication across a free propagation region via a spatial filter, wherein the spatial filter is defined by selective doping of the optic chip.

2. An integrated optic device according to claim 1, wherein the optic chip is a silicon-on insulator chip.

3. An integrated optic device according to claim 1 wherein the spatial filer includes an undoped region of relatively low opacity sandwiched between doped regions of relatively high opacity.

4. An integrated device according to claim 3 wherein the doping of the doped regions of relatively high opacity is controlled such that the opacity of the doped regions increases with increasing distance from the undoped region.

5. A integrated device according to claim 1, wherein the first and second optic components are diffraction gratings separated by a free propagation region, the spatial filter defined by doping selected portions of the free propagation region such that, in use, a selected portion of light output from the first diffraction grating into the free propagation region is preferentially directed to the second diffraction grating.

6. A wavelength-dispersive device for processing a multi-channel optic signal, the device including an optic chip defining first and second diffraction gratings coupled via a first free propagation region, the second diffraction grating coupled at its output end to an array of light-receiving elements via a second free propagation region, each light-receiving element positioned to selectively receive a respective channel of the multi-channel signal and wherein the first free propagation region includes a spatial filter defined by selective doping of the optic chip so as to preferentially transmit a selected portion of the output from the first diffraction grating to the second diffraction grating and thereby reduce cross-talk at the array of light-receiving elements.

7. A device according to claim 6 wherein the first and second diffraction gratings are array waveguide gratings.

8. A device according to claim 7, wherein the free spectral range of the first array waveguide grating is substantially equal to the frequency spacing of the array of light-receiving elements.

9. A device according to claim 6 wherein the array of light-receiving elements comprises an array of waveguides.

10. A method of demultiplexing a wavelength division multiplexed optic signal using the device according to claim 7, wherein the first array waveguide grating has a free spectral range substantially equal to that of the channel spacing of the wavelength division multiplexed optic signal.
